(19) United States
(12) Patent Application Publication
(10) Pub. No.: US 2013/0047611 A1
(43) Pub. Date: Feb. 28, 2013

(54) SOLAR POWER PLANT PART OF A SOLAR THERMAL POWER PLANT AND SOLAR THERMAL POWER PLANT PROVIDED WITH SOLAR COLLECTOR SURFACES FOR A HEAT TRANSFER MEDIUM AND WORKING MEDIUM

(71) Applicants: Jan Brückner, Uttenreuth (DE); Joachim Franke, Nurnberg (DE)

(72) Inventors: Jan Brückner, Uttenreuth (DE); Joachim Franke, Nurnberg (DE)

(21) Appl. No.: 13/696,312

(22) PCT Filed: Apr. 28, 2011
(86) PCT No.: PCT/EP2011/056711

§ 371 Date: Nov. 6, 2012

(30) Foreign Application Priority Data
May 6, 2010 (DE) 102010028692.3
Jul. 15, 2010 (DE) 102010027226.4

(51) Int. Cl. F03G 6/06

(52) U.S. Cl. 60/641.15

(57) ABSTRACT

A solar power plant part of a solar thermal power plant including a first solar collector surface which is arranged in one section of a heat transfer medium circuit is provided. A second solar collector surface is arranged in the solar power plant part as a super heater for a working medium which may be released for technical work in a turbine. A solar thermal power plant which includes a solar power plant part is also provided. The solar thermal plant includes a working medium circuit and a steam turbine. A method for operating a solar thermal power plant is also provided.

### CROSS REFERENCE TO RELATED APPLICATIONS

This application is the US National Stage of International Application No. PCT/EP2011/056711, filed Apr. 28, 2011 and claims the benefit thereof. The International Application claims the benefits of German applications No. 10 2010 028692.3 DE filed May 6, 2010 and No. 10 2010 027 226.4 filed Jul. 15, 2010. All of the applications are incorporated by reference herein in their entirety.

### FIELD OF INVENTION

The invention relates to a solar power station part of a solar-thermal power station having solar collector surfaces for a heat carrier medium and a working medium, and to a solar-thermal power station. The invention furthermore relates to a method for operation of a solar-thermal power station.

### BACKGROUND OF INVENTION

Solar-thermal power stations represent an alternative to conventional electricity generation. At the moment, solar-thermal power stations are designed with parabolic groove collectors and indirect vaporization.

In one embodiment of this solar-thermal power station, the heat carrier medium is heated in the parabolic groove collectors. The hot heat carrier medium emits its energy in a downstream heat exchanger (steam generator) to the feed water coming from the condenser. The steam which is produced is fed to a steam turbine.

By way of example, thermal oil is used as the heat carrier medium. The maximum permissible temperature of this thermal oil is about 400° C. Higher temperatures would result in the oil decomposing. When the oil temperature approaches this critical value, either the mirror is rotated away from the focus, or the flow rate of the oil is increased. In consequence, the maximum high-pressure temperature and the hot intermediate superheater temperature of the steam which is produced are not above about 390° C. The pressure of the steam that is produced is 100 to 120 bar.

Maximum water-steam circuit efficiencies of 38% can be achieved with these steam temperatures.

### SUMMARY OF INVENTION

The object of the invention is to considerably increase the comparatively low efficiencies of said apparatus and said method.

According to the invention, this object is achieved by the apparatus as claimed in the claims, by the apparatus as claimed in the claims, and by the method as claimed in the claims. Advantageous developments of the invention are defined in the respective dependent claims.

It is proposed that, in the case of a solar power station part of a solar-thermal power station, having a first solar collector surface which is arranged in a subsection of a heat carrier medium circuit, a second solar collector surface be arranged in the solar power station part as a superheater for a working medium, which can be expanded in a turbine with technical work being output.

The invention is accordingly based on the idea of applying a heat carrier medium to a part of the overall solar collector surface, and of using this for preheating, vaporization and slight superheating. The working medium flows directly through the remaining part of the overall solar collector surface, and can be heated to higher temperatures (e.g. 600° C.) than the heat carrier medium.

The solar power station part advantageously comprises a third solar collector surface as an intermediate superheater for the working medium. After first being expanded in the high-pressure part of the turbine, the steam can thus also be intermediately superheated to higher temperatures than when heat is exchanged with a heat carrier medium at a lower temperature.

The heat carrier medium is expediently a thermal oil. The major advantage of thermal oil over water is the considerably higher boiling point. A temperature of more than 300° C. can thus be reached without problems relating to steam states and increased pressures becoming significant. It is likewise expedient for the working medium to contain water.

The solar collector surfaces are advantageously parabolic groove collector surfaces. Parabolic groove technology is the most cost-effective variant for solar collector surfaces at the moment.

In an alternative advantageous refinement, the solar collector surfaces are Fresnel collector surfaces. The advantages of Fresnel technology over parabolic groove technology are the simple design of the Fresnel collector and the capability to use the space under the collector. A further advantage is the pipe system, because there is no need to change the flow direction because of the pipe length of several hundred meters as a result of which pressure losses in Fresnel collectors are comparatively low.

The first solar collector surface advantageously comprises parabolic groove or Fresnel collectors, and the second solar collector surface comprises a tower heating surface. Parabolic groove and Fresnel collectors normally have a heat carrier medium applied to them and can be used reliably up to pressures of 20 to 30 bar. They are therefore suitable for use as first solar collector surfaces. Designing parabolic groove and Fresnel collectors for the high pressures of the working medium can lead to mechanical problems. For these reasons, the second solar collector surface comprises a solar tower, which is stationary and whose tower heating surface is illuminated by tracked flat mirrors.

The third solar collector surface expediently likewise comprises a tower heating surface.

According to the invention, the object relating to a solar-thermal power station is achieved by a solar-thermal power station comprising a solar power station part, a working medium circuit in which a steam turbine is arranged, a first heat exchanger for transmission of heat from the heat carrier medium circuit to the working medium circuit, with the primary side of the heat exchanger being connected in the heat carrier medium circuit, and with the secondary side being connected in the working medium circuit, wherein the superheater is connected downstream from the first heat exchanger in the flow direction of the working medium, in the working medium circuit.

This results in the temperature levels being matched to the respective requirements. The heat carrier medium circuit, which is subject to an upper temperature limit, ensures that the working medium is heated and vaporized by exchanging heat with it, and the working medium is then itself heated to even higher temperatures in the superheater.

In this case, it is expedient for the superheater to be connected upstream of the turbine in the flow direction of the working medium.

It is advantageous for the steam turbine to comprise a high-pressure stage and for an intermediate superheater to be connected downstream from the high-pressure stage. This allows the energy of the steam that is produced to be utilized better.

A further heat exchanger, which is connected downstream from the first heat exchanger in the flow direction of a heat carrier medium, and is connected upstream of the first heat exchanger in the flow direction of a working medium, is likewise advantageous because, in this case, the residual heat in the heat carrier medium can be used to preheat the working medium.

In the method according to the invention for operation of a solar-thermal power station, comprising a solar power station part having a first solar collector surface and a second solar collector surface, and a conventional power station part having a turbine, a heat carrier medium flows through the first solar collector surface and heats and vaporizes a working medium with heat being exchanged, with the steam which is produced flowing through a second solar collector surface and then being fed to a turbine.

It is advantageous for steam which has been expanded in a high-pressure part of the turbine to flow through a third solar collector surface for intermediate superheating.

In conjunction with raising the turbine inlet pressure to, for example 260 bar, the inventive solar power station part, the inventive solar-thermal power station and the method according to the invention allow the efficiency in the water-steam circuit to be increased to 42-47%. The proposed measure therefore allows the efficiency to be increased by up to 10% points.

In the previous embodiments of solar-thermal power stations, the power station efficiency is limited. The novel measure allows the efficiency to be increased considerably. This means that, for example, more electricity can be generated from a given collector area.

### BRIEF DESCRIPTION OF THE DRAWINGS

By way of example, the invention will be explained in more detail with reference to the drawings in which, illustrated schematically and not to scale:

FIG. 1 shows a solar-thermal power station according to the prior art, and

FIG. 2 shows a solar-thermal power station according to the invention.

### DETAILED DESCRIPTION OF INVENTION

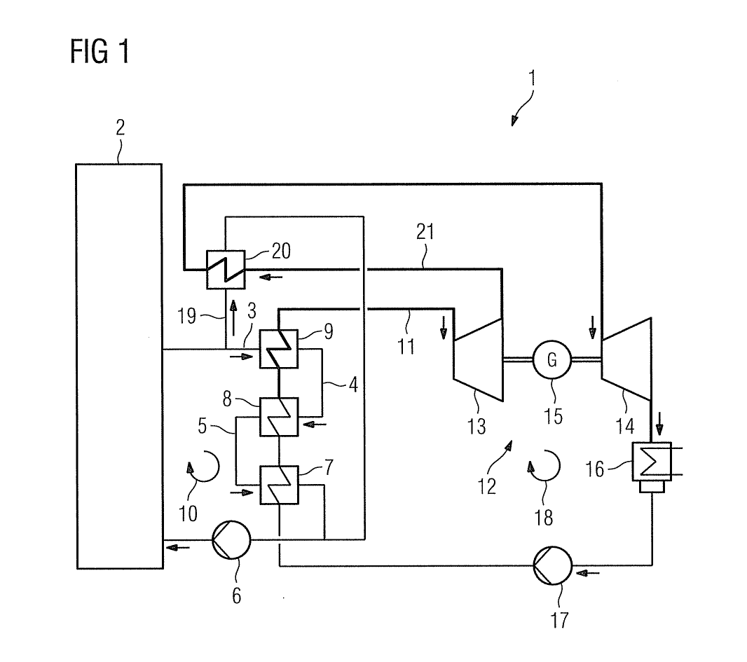

FIG. 1 shows, schematically and by way of example, the design of a solar-thermal power station 1 according to the prior art.

The solar-thermal power station 1 comprises a solar array 2, in which the solar radiation is concentrated and is converted to thermal energy. The solar array 2 may, for example, have parabolic groove collectors or Fresnel collectors. Concentrated solar radiation is emitted to a heat carrier medium, for example thermal oil, whose boiling point is considerably higher than that of water, thus allowing temperatures of 300-400° C. to be achieved. The heat carrier medium is transported via pipelines 3, 4, 5, by means of a thermal-oil pump 6, to heat exchangers 7, 8, 9, in which a working medium, for example water, is heated 7, is vaporized 8, and the steam that is produced is superheated 9, with the heat carrier medium being cooled down again. The heat carrier medium which has been cooled down is pumped back into the solar array 2, thus resulting in a closed heat carrier medium circuit 10.

The superheated steam is introduced as a working medium into a steam turbine 12 via a fresh steam line 11 in the so-called conventional part of the solar-thermal power station 1. The steam turbine 12 comprises a high-pressure stage, which is in the form of a separate high-pressure turbine element 13, and a combined medium-pressure/low-pressure turbine element 14 for the medium-pressure stage and the low-pressure stage. An embodiment with a medium-pressure stage which is in the form of a separate medium-pressure turbine element, and a low-pressure stage which is in the form of a separate low-pressure turbine element, is likewise feasible. The turbine elements 13, 14 drive a generator 15. The working medium is expanded in the steam turbine 12, and is then liquefied in a condenser 16. A feed water pump 17 pumps the liquefied working medium back again to the heat exchangers 7, 8, 9, thus closing the circuit 18 of the working medium.

In order to superheat the cooled-down intermediate superheating steam downstream from the high-pressure stage 13, a portion of the heat carrier medium taken from the solar array 2 is fed via the pipeline 19 to the primary side of a heat exchanger 20, and the steam which has been partially expanded downstream from the high-pressure stage 13 is fed via a steam line 21 to the secondary side of the heat exchanger 20, such that the heat exchanger 20 acts as an intermediate superheater.

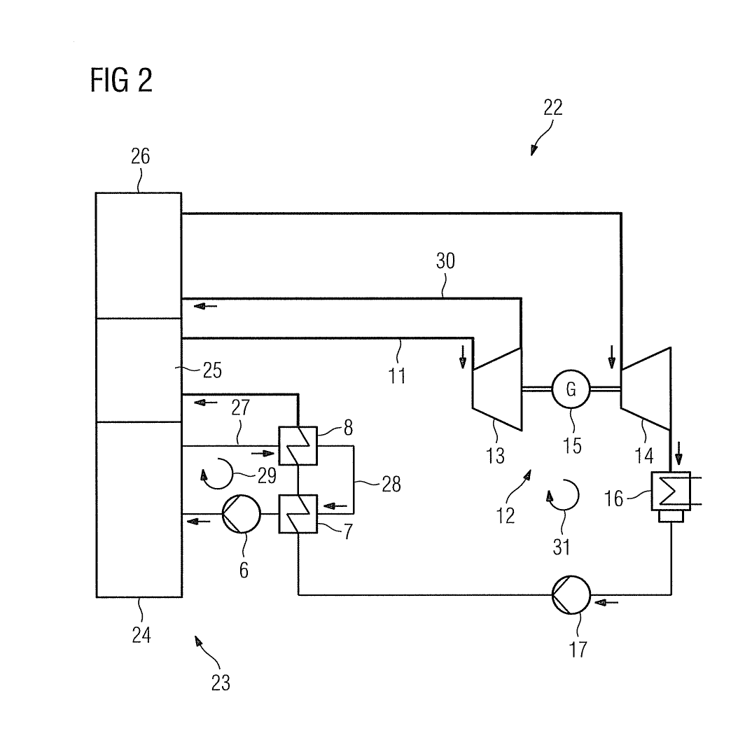

FIG. 2 shows a solar-thermal power station 22 according to the invention. The inventive solar power station part 23 now no longer comprises a solar array with a single, large solar collector surface, but various solar collector surfaces 24, 25, 26, for example with the first solar collector surface 24 comprising parabolic groove or Fresnel collectors, and with the second and the third solar collector surfaces 25, 26 comprising tower heating surfaces, which are illuminated by flat mirrors (not shown).

The heat carrier medium is transported via pipelines 27 and 28, by means of a thermal-oil pump 6, from the first solar collector surface 24 to heat exchangers 7 and 8, in which the working medium is heated 7, vaporized 8, and the steam which is produced is possibly slightly superheated, with the heat carrier medium cooling down again. The heat carrier medium which has cooled down is pumped back to the first solar collector surface 24 in the solar power station part 23, such that the response again also results in a closed heat carrier medium circuit 29 here.

The steam which is produced in this way then flows through the second solar collector surface 25, and is superheated in the process. The superheated steam is introduced as the working medium via the fresh-steam line 11 into the high-pressure turbine element 13 of the steam turbine 12.

In order to superheat the cooled-down intermediate superheating steam downstream from the high-pressure stage 13, the steam is fed via the steam line 30 to the third solar collector surface 26. The superheated steam is then fed into the medium-pressure/low-pressure turbine element 14, where it is expanded and then liquefied in the condenser 16. As described in FIG. 1, the feed water pump 17 in this case as well pumps the liquefied working medium, that is to say the water, back again to the heat exchangers 7 and 8, thus closing the circuit 31 of the working medium.

1-13. (canceled)

14. A solar power station part of a solar-thermal power station, comprising:
a first solar collector surface which is arranged in a subsection of a heat carrier medium circuit; and
a second solar collector surface arranged in the solar power station part as a superheater for a working medium, which may be expanded in a turbine with technical work being output.

15. The solar power station part as claimed in claim 14, further comprising a third solar collector surface as an intermediate superheater for the working medium.

16. The solar power station part as claimed in claim 14, wherein a heat carrier medium is a thermal oil and wherein the working medium comprises water.

17. The solar power station part as claimed in claim 14, wherein the solar collector surfaces are parabolic groove collector surfaces.

18. The solar power station part as claimed in claim 14, wherein the solar collector surfaces are Fresnel collector surfaces.

19. The solar power station part as claimed in claim 14,
wherein the first solar collector surface comprises parabolic groove or Fresnel collectors, and
wherein the second solar collector surface comprises a tower heating surface.

20. The solar power station part as claimed in claim 15, wherein the third solar collector surface comprises a tower heating surface.

21. A solar-thermal power station, comprising:
a solar power station part as claimed in claim 14;
a working medium circuit in which a steam turbine is arranged;
a first heat exchanger for transmission of heat from a heat carrier medium circuit to the working medium circuit,
wherein the primary side of the heat exchanger is connected in the heat carrier medium circuit,
wherein the secondary side is connected in the working medium circuit, and
wherein the second solar collector surface is connected as a superheater downstream from the first heat exchanger in the flow direction of the working medium, in the working medium circuit.

22. The solar-thermal power station as claimed in claim 21, wherein the superheater is connected upstream of the steam turbine in the flow direction of the working medium.

23. The solar-thermal power station as claimed in claim 21,
wherein the steam turbine comprises a high-pressure stage, and
wherein an intermediate superheater is connected downstream from the high-pressure stage.

24. The solar-thermal power station as claimed in claim 21, further comprising a further heat exchanger which is connected downstream from the first heat exchanger in the flow direction of a heat carrier medium, and is connected upstream of the first heat exchanger in the flow direction of a working medium.

25. A method for operation of a solar-thermal power station, comprising:
providing a solar power station part having a first solar collector surface and a second solar collector surface;
providing a conventional power station part having a turbine,
wherein a heat carrier medium flows through the first solar collector surface, the heated heat carrier medium heats a working medium, and vaporizes it, with heat being exchanged, and
wherein the steam which is produced flows through a second solar collector surface and is then fed to the turbine.

26. The method as claimed in claim 25, wherein steam which has been expanded in a high-pressure part of the turbine flows through a third solar collector surface for intermediate superheating.
